(19) United States
(12) Patent Application Publication
(10) Pub. No.: US 2005/0183302 A1
(43) Pub. Date: Aug. 25, 2005

(54) Color-changing information sysmbol

(76) Inventor: Sheng-Chien Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/781,833

(22) Filed: Feb. 20, 2004

(51) Int. Cl. G09F 13/00

(52) U.S. Cl. 40/547; 40/433; 40/581

(57) ABSTRACT

A color-changing information symbol includes a board, a bulletin portion formed on the board, and a lighting device having multiple optical fibers to connect with and illuminate the bulletin portion. The lighting device contains a light source projecting light to the optical fibers and a transparent color wheel rotatably located between the light source and the optical fibers to change the color of light. Thereby, the bulletin portion shows twinkling and varying colors to make the information symbol attractive and conspicuous.

### BACKGROUND OF THE INVENTION

1. Field of the Invention

The present invention relates to a color-changing information symbol, and more particularly to a color-changing information symbol that shows vivid colors by means of an optical fiber device fitted thereon.

2. Description of Related Art

Conventional information devices such as traffic signs usually do not have lighting devices so that the information symbols are not conspicuous especially in the dark and drivers easily miss the information symbols. Some conventional information symbols have lighting devices composed of multiple lamps. However, each lighting device consumes more electricity when more lamps are attached to the information symbols. Additionally, the configuration of the information symbols is limited because the lamps are not flexible to freely mount on the information symbols to achieve any image.

Optical fiber is a preferred option to replace the lamps because optical fibers have excellent flexibility and can be shaped in different configurations easily to meet design aspects. Each optical fiber is made of a glass core (SiO₂) coated with a light-blocking layer and has two ends. When light enters the optical fiber at one end, it transmits through the glass core rapidly and emits out at the other end. The light-blocking layer prevents light emitting from periphery of the optical fiber to ensure the light completely passing through the optical fiber. Selectively, parts of the light-blocking layer can be removed to make the light emit at some desired places on the optical fiber to correspond to requirements in design. Moreover, a bunch of optical fibers only needs one lighting source whereby the consumption of the electricity is reduced in comparison to conventional lamps.

The present invention has arisen to combine the optical fibers on the information symbol to mitigate or obviate the disadvantages of the conventional information symbol with lamps.

### SUMMARY OF THE INVENTION

The main objective of the present invention is to provide a color-changing information symbol that uses optical fibers to compose bulletin portions to show vivid colors and to attract people's attention.

Further benefits and advantages of the present invention will become apparent after a careful reading of the detailed description with appropriate reference to the accompanying drawings.

### BRIEF DESCRIPTION OF THE DRAWINGS

FIG. 1 is a front plane view of a standing base having a color-changing information symbol in accordance with the present invention;

FIG. 2 is a rear plane view of the color-changing information symbol in FIG. 1;

FIG. 3 is a perspective view of a lighting device attached behind the standing base;

FIG. 4 is a front plane view of the light device in FIG. 3; and

FIG. 5 is perspective view of the light device with a housing.

### DETAILED DESCRIPTION OF THE PREFERRED EMBODIMENT

A color-changing information symbol in accordance with the present invention comprises a board, a bulletin portion formed on the board, and a lighting device having multiple optical fibers to connect with and make the bulletin portion bright with twinkling and varying colors. Wherein, the bulletin portion can be performed in a flat configuration or in stereo configuration in different symbols such as words or patterns.

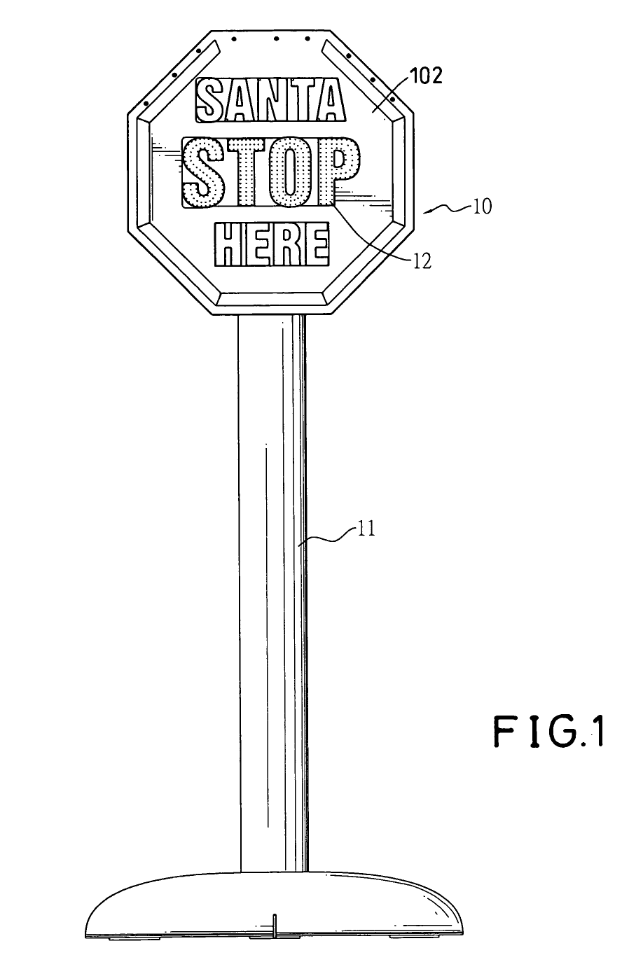

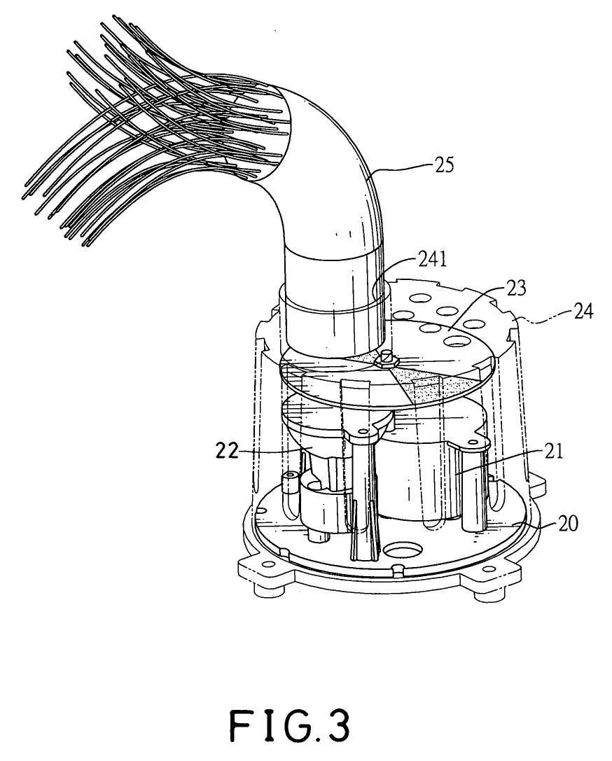

With reference to FIGS. 1 and 3, the color-changing information symbol (10) is mounted on a standing base (11). The color-changing information symbol (10) has a board (102) secured on a top of the standing base (11), at least one wording bulletin portion (12), and a lighting device (20). The board (102) has a front face (not numbered) and a rear face (not numbered) and the at least one wording bulletin portion (12) is formed on the front face of the board (102).

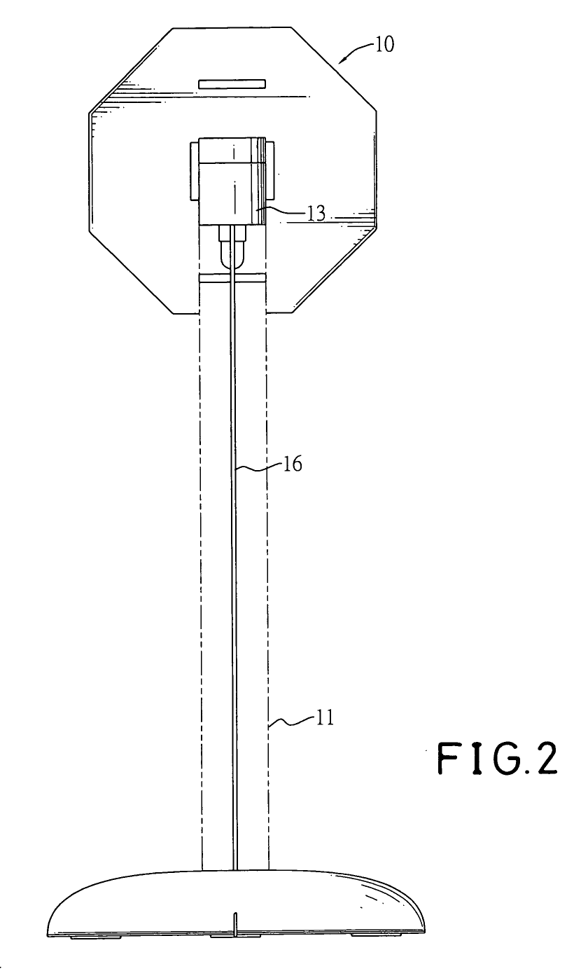

With further reference to FIG. 2, the rear face of the board (102) further has a case (13) to accommodate the lighting device (20) and a wire (16) electrically connected between the lighting device (20) and a power source (not shown).

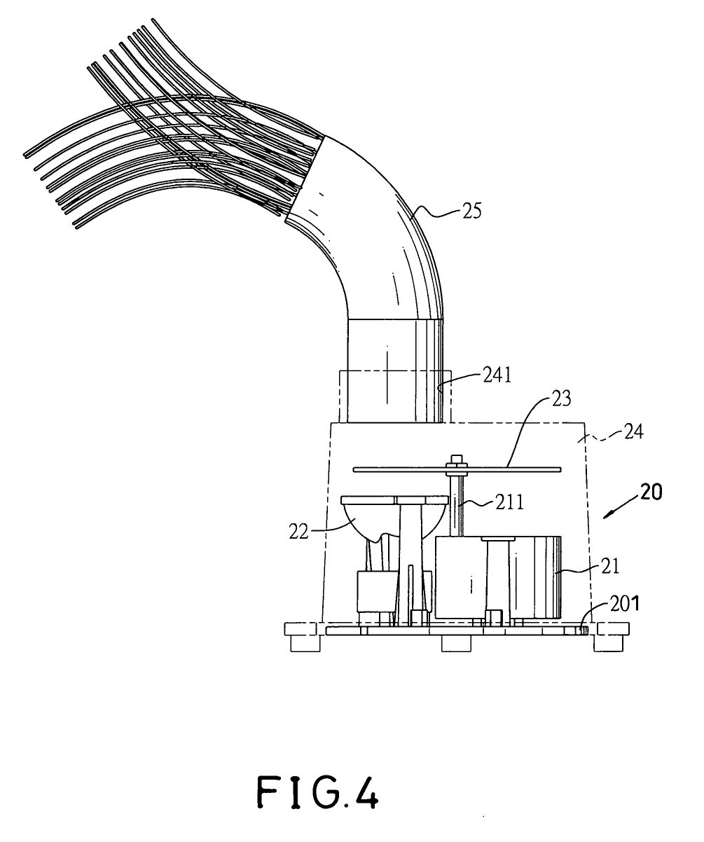

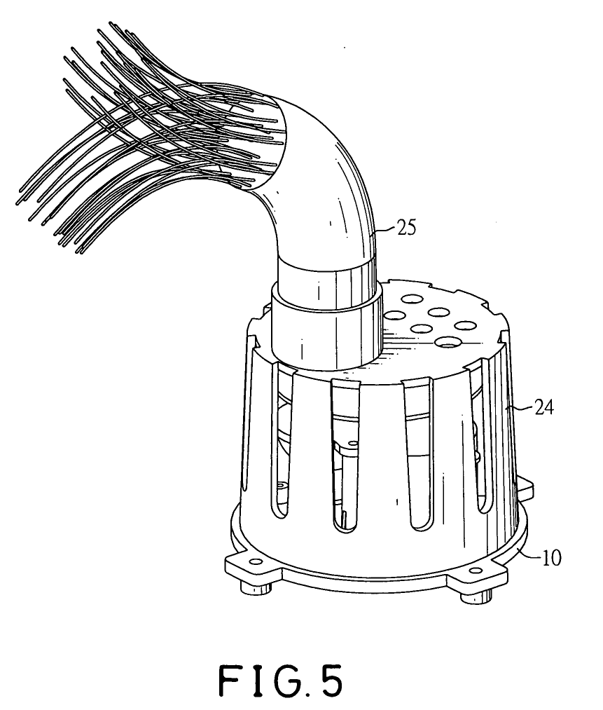

With reference to FIGS. 3 to 5, the lighting device (20) comprises a base plate (201), a driving device such as a motor (21) with a driving shaft (211), a color wheel (23), a housing (24), a light source (22), and a bunch of optical fibers (25). The motor (21) is mounted on the base plate (201) and rotates the driving shaft (211). Selectively, the driving device can be other motorized systems such as a cylinder to move the color wheel (23). The color wheel (23) is attached on the driving shaft (211) and is made of transparent material to allow light to pass through it. The color wheel (23) has multiple areas with different colors to change the color of light. The light source (22) is mounted on the base plate (201) under the color wheel (23) to emit the light directly to the color wheel (23). The housing (24) is mounted on the base plate (201) and covers the motor (21), the color wheel (23) and the light source (22). The housing (24) has a flat top and a connecting access (241) formed on the flat top and communicating with inside of the housing (24). The bunch of optical fibers (25) is composed of multiple strings of optical fiber and has two ends. One end of the bunch of optical fibers (25) is received inside the connecting access (241) to align with the light source (22) and the other end is branched to individually attach to each string of optical fiber on the wording bulletin portion (12) to form the patterns on the board (102).

When the color-changing information symbol operates, the light source (22) emits light to the bunch of optical fibers (25). However, the light has to pass through and is filtered by the color wheel (23) to change the color of light. Meanwhile, the motor (21) drives the color wheel (23) to rotate to make light pass through different areas on the color wheel (23) and to change colors. Thereby, light with different colors travels through the bunch of optical fibers (25) and emits from the wording bulletin portion (12) so that the information symbol is conspicuous and attractive.

According to the above description, the color-changing information symbol has several advantages as follows:
1. The bulletin portion is particularly emphasized by varying or twinkling lights with different colors so the information symbol is conspicuous especially in the dark, whereby people are well informed.
2. Because the optical fiber has excellent flexibility to attach on the board, the configuration of the bulletin portion can be freely designed in complex patterns.
3. The color-changing information symbol uses only a single light source for all the optical fiber strings, therefore, electricity consumption of the color-charging information symbol is constant even when the quantity of optical fiber strings is high.

Although the invention has been explained in relation to its preferred embodiment, it is to be understood that many other possible modifications and variations can be made without departing from the spirit and scope of the invention as hereinafter claimed.

1. A color-changing information symbol comprising:
a board (102) with a front face and a rear face;
at least one bulletin portion (12) formed on the front face of the board; and
a lighting device attached on the rear face of the board and comprising:
a base plate (201);
a driving device mounted on the base plate (201);
a color wheel (23) having two sides, made of transparent material in different colors and driven by the driving device;
a light source (22) mounted on the base plate (201) to project light on one side of the color wheel (23);
a housing (24) combined to the base plate (201) to cover the driving device, color wheel (23) and the light source (22) and having a connecting access (241) communicating with an interior of the housing (24); and
a bunch of optical fibers (25) having multiple optical fiber strings and two ends, one end received in the connecting access (241) to align with the light source (22) via the other side of the color wheel (23) and the other end branched to individually attach the multiple optical fiber strings to the at least one bulletin portion (12).

2. The color-changing information symbol as claimed in claim 1, wherein the board (102) further has a case (13) attached on the rear face of the board (102) to accommodate the lighting device (20).

3. The color-changing information symbol as claimed in claim 1, wherein driving device (20) is composed of a motor (21) and a driving shaft (211) mounted on the motor (20) and extending to connect with the color wheel (23).

4. The color-changing information symbol as claimed in claim 2, wherein driving device (20) is composed of a motor (21) and a driving shaft (211) mounted on the motor (20) and extending to connect with the color wheel (23).
